(19) United States
(12) Patent Application Publication
(10) Pub. No.: US 2003/0026876 A1
(43) Pub. Date: Feb. 6, 2003

(54) Multi-component pet food packaging

(76) Inventors: Mario Albuja, St. Joseph, MO (US); Carlos Aguilar, St. Joseph, MO (US); Albert Baner, St. Joseph, MO (US)

Correspondence Address: Bell, Boyd & Lloyd LLC, P.O. Box 1135, Chicago, IL, 60690-1135, US

(21) Appl. No.: 09/990,736

(22) Filed: Nov. 21, 2001

Related U.S. Application Data
(63) Continuation-in-part of application No. 09/682,177, filed on Jul. 31, 2001.

(51) Int. Cl. A23B 4/00

(52) U.S. Cl. 426/120

(57) ABSTRACT

An improved pet food snack and container for holding same and for providing and dispensing a dry pet food snack in combination with a highly palatable paste or sauce is provided. The container houses separate first and second pet foods. The container has a removable lid that automatically places the first and second pet foods into contact when the lid is removed. The container has a bowl that holds the contacted first and second pet foods. The bowl is suitable for serving the contacted first and second pet foods to a pet. A pet owner can open the container and serve the contacted first and second pet foods without using any separate utensils.

### PRIORITY CLAIM

This application is a continuation-in-part application of U.S. patent application Ser. No. 09/682,177, filed on Jul. 31, 2001 entitled “Multi-Compartment Pet Food Container.”

### BACKGROUND OF THE INVENTION

The present invention relates generally to pet food. More particularly, the present invention relates to pet food containers including pet food.

A variety of pet food products are available to consumers. These products range from products providing complete nutritional support to snacks. These products are available in a variety of shapes, sizes and forms. Pet food and to a certain extent pet food snacks are adapted to provide complete nutrition to the pet. Certain pet foods are further adapted to improve immunity to or fight or control disease. While nutrition is one important factor, the pet food and pet food snacks should be palatable, so that the pet consumes the required amount necessary for proper nutrition. A pet owner is unlikely to repeatedly buy pet food or pet food snacks that the pet will not eat.

Canned or high moisture pet food products, containing meat and typically having a moisture content above fifty percent by weight are usually more palatable than dry pet food.

However, dry pet food is a highly nutritional form of pet food. The relatively low moisture content of dry pet food permits a higher degree of nutritional balancing of ingredients. Moreover, dry pet food provides benefits to the dental hygiene of pets. In this regard, the action of biting and chewing dry pet products helps to remove tartar from the teeth of pets.

Dry pet food also provides other advantages. Dry pet food is typically less expensive than a similar quantity of wet pet food. When exposed to ambient conditions, the dry pet food also stays fresher for a longer period of time. This allows the pet owner to leave dry pet food in a dish for consumption by the pet for an extended period of time. the dry pet food also stays fresher for a longer period of time. This allows the pet owner to leave dry pet food in a dish for consumption by the pet for an extended period of time.

A variety of efforts have been made to make dry pet food more palatable to pets. Likewise, a variety of efforts have been made to make dry pet food more desirable to pet owners. For example, the pet food industry has added palatability enhancers to the dry food. While such product enhancers have been effective, a need continuously exists to improve the palatability of dry pet food and the popularity of dry pet food snacks.

### SUMMARY OF THE INVENTION

The present invention provides an improved pet food snack. More specifically, the present invention provides methods and products for providing and dispensing a dry pet food product in combination with a wet meal component, a highly palatable paste or sauce or a functional ingredient.

To this end, in an embodiment of the present invention, a pet food container including pet food is provided. The container includes a tray, a dry food compartment formed in the tray including a unit of dry pet food and a wet food compartment formed in the tray including a quantity of wet pet food.

In an embodiment, the dry pet food compartment is spatially adapted to maintain a number of dry pet food units in a packaged order.

In an embodiment, the dry pet food comprises a powdered meal supplement. The supplement preferably includes a functional ingredient. The functional ingredient in an embodiment includes a probiotic micro-organism, or a moiety of its culture. Such moiety in an embodiment includes a cell fragment, a metabolite or a supernatant of its culture.

In an embodiment, the wet pet food is a flavored cream paste.

In an embodiment, the wet pet food includes oils and fats.

In an embodiment, the wet pet food is shelf stable.

In an embodiment, the wet pet food includes a functional ingredient. The functional ingredient in an embodiment includes a probiotic micro-organism or a moiety of its culture. Such moiety in an embodiment includes a cell fragment, a metabolite or a supernatant of its culture.

In an embodiment, the container includes a second wet food compartment formed in the tray having a quantity of a second wet pet food.

In an embodiment, the container includes a resealable lid.

In another embodiment of the present invention, a pet food container is provided. The pet food container includes a tray and a plurality of pet food compartments formed in the tray. The pet food compartments are individually spatially adapted to hold a particular quantity and type of pet food. At least one compartment is moisture impermeable and thereby adapted to hold a quantity of wet pet food without leaking. The container also includes a resealable lid removably attached to the container. The lid is adapted to seal the compartments from ambient air.

In an embodiment, the tray is plastic.

In an embodiment, the tray is fiber-based, e.g., the tray may be of fiberboard, cardboard or barrierboard, or of a laminate including the one of the same.

In an embodiment, the resealable lid is adapted to individually seal each compartment.

In a further embodiment of the present invention, a pet food product comprises a container defining at least two airtight compartments for the separate storage of separated meal components and different meal components separately stored in the respective compartments.

In an embodiment, one of the components is a dry pet food or treat and the other component is a flowable foodstuff or food supplement. The supplement in an embodiment includes a microorganism or a metabolic moiety thereof.

In an embodiment, the container is a pouch.

In an embodiment, the container includes at least one removable separating device, so that the different meal components may be combined. The removable separating device allows for mixing of the separate components prior to dispensing or serving.

In an embodiment, the container includes a crease so that one pet food compartment may be folded over another pet food compartment.

In a still further embodiment of the present invention, a pet food container including dry and wet pet food is provided. The pet food container includes a unit of dry pet food stored in the tray. The dry pet food includes a surface that is designed to hold a quantity of wet pet food, which is also stored in the tray.

In an embodiment, the dry pet food product includes a body that has a rectangular shape.

In an embodiment, the dry pet food product is shaped to define a scoop. The product in an embodiment has a spoon shape.

In a further embodiment of the present invention, a method for providing a pet food product is provided. The method includes the step of providing a container that houses a plurality of pet foods. The container includes a quantity of dry pet food units and a quantity of a first wet pet food. The dry pet food units have a surface adapted to hold a quantity of the first wet pet food. The method includes the steps of enabling a consumer to grasp and remove a dry pet food unit and use the dry pet food unit to remove a quantity of the first wet pet food and present the dry pet food unit with the wet pet food to a pet.

In an embodiment, the method includes the further step of enabling the consumer to use the dry food unit to remove a quantity of a second wet pet food.

In yet another embodiment of the present invention, a pet food container having pet food is provided. The container includes a housing or bowl. First and second pet foods are disposed within the housing or bowl. A lid is provided that is so constructed and arranged that when the lid is removed from the housing or bowl, the removal of the lid causes the first and second pet foods to contact each other.

In an embodiment, the bowl is plastic and microwaveable.

In an embodiment, the bowl is sized to be dispensed from a vending machine.

In an embodiment, the lid is resealable.

In an embodiment, the first pet food is dry and the second pet food is wet.

In an embodiment, the first pet food is semi-dry and the second pet food is wet.

In an embodiment, the wet pet food includes a medicament or a neutraceutical in a dosage amount calculated for a pet.

In an embodiment, the second pet food is stored in a package. The package is disposed inside the bowl and ruptured when the lid is removed from the bowl.

In an embodiment, the package is predisposed to tear along a tear line of the package.

In an embodiment, the lid is predisposed to buckle and thereby cause the package to rupture.

In an embodiment, the second pet food is stored in a package and the lid punctures the package when the lid is removed from the bowl.

In an embodiment, the second pet food is disposed directly underneath the lid and above the first pet food.

Moreover, in another embodiment of the present invention a pet food container for serving to a pet is provided. The container includes a housing or bowl having a non-sharp rim that enables the pet to contact the rim. Pet food is maintained within the housing or bowl. A lid seals to the bowl and keeps the pet food fresh. A tab extends from the lid. The tab enables the lid to be grasped to remove the lid from the bowl.

In an embodiment, the lid seals to the rim and the tab extends from the rim along an edge of the lid.

In an embodiment, the tab is disposed on top of the lid.

In an embodiment, the bowl is sized to hold a quantity of the pet food. The quantity is consumable in a single feeding.

Further, in an additional embodiment of the present invention, a method for providing a pet food container is provided. The method includes producing a container that houses separate first and second pet foods. The container has a removable lid that automatically places the first and second pet foods into contact when the lid is removed. The container has a bowl that houses the first and second pet foods. The bowl is suitable for serving the contacted first and second pet foods. The method then includes distributing the container to a retail outlet.

In an embodiment, the second pet food is wet pet food that is stored in a package that automatically ruptures when the lid is removed from the container.

In an embodiment, the retail outlet is a supermarket, a convenience store, a quick service restaurant or a vending machine.

Additionally, in another embodiment of the present invention, a method for providing a pet food container is provided. The method includes providing a container that houses separate first and second pet foods. The container has a removable lid that automatically places the first and second pet foods into contact when the lid is removed. The container has a bowl that houses the first and second pet foods. The bowl is suitable for serving the contacted first and second pet foods. The method then includes opening the container and serving the contacted first and second pet foods.

In an embodiment, the method includes unsealing the lid from the bowl.

In an embodiment, the method includes opening the container and serving the contacted first and second pet foods without any additional tool or utensil.

An advantage of the present invention is to provide improved pet food snacks.

Another advantage of the present invention is to provide improved pet food containers.

Furthermore, an advantage of the present invention is to provide an improved pet food including a dry pet food component and a wet pet food component.

Still further, an advantage of the present invention is to provide a convenient and attractive method of providing pet food products to a consumer.

Moreover, an advantage of the present invention is that it provides a complete product that allows the consumer to provide their pet with a wet pet food product without the need for utensils. It provides a means for taking components of a complete meal or snack in a portable configuration that is conveniently preparable by a traveler.

Further, an advantage of the present invention is that it provides a more palatable dry pet food.

Additionally, it is an advantage of the present invention to provide a pet food container that may be served to a pet.

Still additionally, it is an advantage of the present invention to provide a pet food container that may be served to a pet without the need for an opener or utensil.

Yet additionally, it is an advantage of the present invention to provide a pet food container that may be served to a pet and thereafter discarded without the need for clean up.

Moreover, it is an advantage of the present invention to provide a pet food container that may be dispensed from a vending machine or provided at a quick service restaurant.

Further still, it is an advantage of the present invention to provide a pet food container that opens a package of wet pet food automatically upon removing a lid from the container.

Yet further, it is an advantage of the present invention to provide a medicated pet food.

Additional features and advantages of the present invention will be described in and apparent from the detailed description of the presently preferred embodiments.

### BRIEF DESCRIPTION OF THE FIGURES

FIG. 1 is a perspective view of a pet food container of the present invention having a tray defining a plurality of pet food compartments.

FIG. 2 is a perspective view of a pet food container of the present invention having a tray with a plurality of different pet foods.

FIG. 3 is a perspective view of a dry pet food unit of the present invention.

FIG. 4 is a perspective view of a dry pet food/wet pet food combination of the present invention.

FIG. 5 is perspective view of another embodiment of the present invention.

FIG. 6 is a perspective view of a further embodiment of the present invention.

FIG. 7 is a perspective view of a still another embodiment of the present invention.

FIG. 8 is an exploded perspective view of yet another embodiment of the present invention.

### DETAILED DESCRIPTION OF THE PRESENTLY PREFERRED EMBODIMENTS

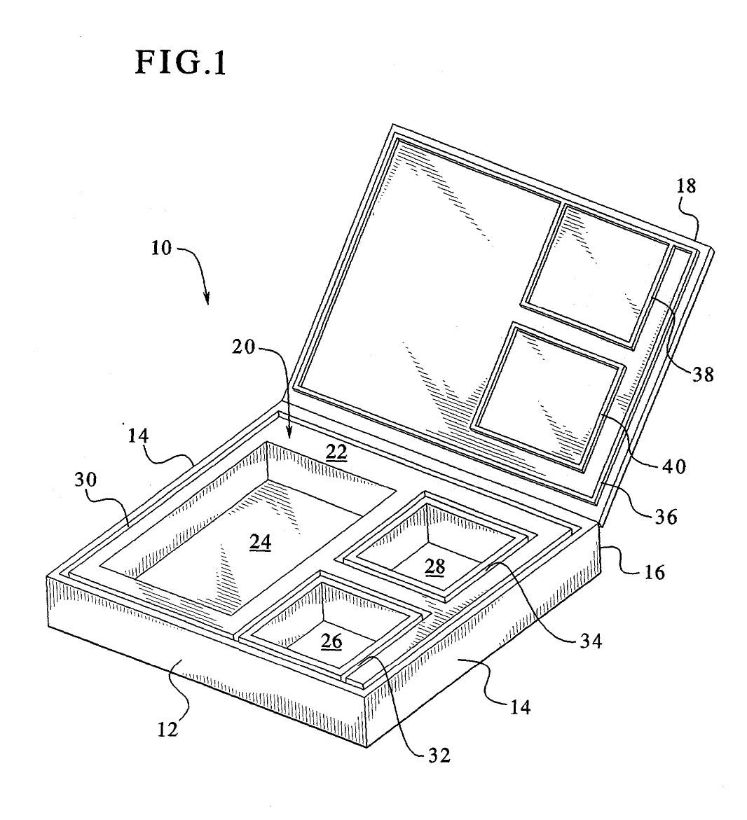

Referring now to FIG. 1, a perspective view of an embodiment of a multiple compartment pet food container 10 of the present invention is illustrated. The container 10 includes a front 12, a plurality of sides 14, a back 16 and a resealable lid 18. In the embodiment illustrated, the lid is adaptable to be opened via a hinge. However, if desired, the lid can be constructed so that it is completely removed. The front 12, sides 14, back 16 and lid 18 are adaptable to be made of any material. For example, the container 10 can be made of a fibrous material such as cardboard, fiberboard, barrierboard, be made of plastic or include a laminate that is made of one of the same. The shape and relative dimensions of the container 10 can vary from the illustrated embodiment, i.e., a generally flat and rectangular container 10, without departing from the scope of the invention. For example, if desired the container 10 can be square or oval.

In the illustrated embodiment, the front 12, sides 14 and back 16 support a tray 20. The tray 20 includes a tray surface 22 and a plurality of separate compartments 24, 26 and 28, which project downwardly into the container 10 from the tray surface 22. The tray surface 22 and the compartments 24, 26 and 28 are preferably formed as one piece via a suitable molding process. The tray is made of plastic or other suitable impermeable material that is suitable to support wet pet food. The tray 20 can also include other attachments or structural members, which are not illustrated, but which enable the container 10 to fix the tray 20 in place and aid the tray 20 in supporting the pet food products described herein.

The compartments 24, 26 and 28 preferably define a volume adapted to support the quantity of pet food product that they are intended to hold. Accordingly, different compartments have different lengths, widths and depths. The compartments are adaptable to have the substantially square or rectangular contours, as illustrated, or to have other straight sided or rounded contours. Although the container 10 is illustrated as having three compartments, the container 10 can have any number of compartments and preferably at least two.

In the illustrated embodiment, the compartment 24 is larger than compartments 26 and 28 and is adapted to hold or package dry pet food and preferably dry pet food having a predetermined shape. The shape and depth of the compartment 24 is preferably adapted to receive a predetermined number of dry food units or other measurement of the dry food, such as a particular weight.

The compartments 26 and 28 are both spatially adapted to hold or package a predetermined quantity of wet pet food and preferably a sauce, paste or shredded wet pet food. The compartments 26 and 28 may be of different sizes to hold more or less of a certain sauce, paste or shredded food and of different shapes to accommodate wet pet foods of different thicknesses. The compartments 26 and 28 are either plastic or otherwise coated with a moisture impermeable coating such as a thin plastic film or wax. The wet food compartments 26 and 28 impermeably hold wet pastes or sauces having any moisture content percentage by weight, including percentages substantially above fifty percent.

As noted above, the container 10 includes a resealable lid 18. The resealable lid 18 is adapted to enable the consumer to open the lid 18, remove a portion of the pet food products from the container 10, close the lid 18 and form a seal that keeps ambient air from contacting the unused pet food portions. The container 10 is adaptable to employ many different known types of reusable seals for disposable containers.

In an embodiment, the tray surface 22 defines a continuous downwardly extending channel 30 that extends along the outer edges of the tray 20. The tray surface 22 defines a similar channel 32 that extends around the wet pet food compartment 26. As illustrated, the channel 32 engages the larger channel 30 along the front side of the wet food compartment 26. The channel 32 alternatively extends around each side of the wet food compartment 26. The tray surface 22 defines a similar channel 34 that extends around each side of the wet pet food compartment 28. The channel 32 alternatively extends around three sides of the wet food compartment 28 and mates with the larger channel 30 along the back side of the wet food compartment 28. Although not illustrated, the tray surface 22 can also define a similar channel around the dry food compartment.

In this embodiment, the lid 18 includes a continuous sealing rib 36, protruding from the inner surface of the lid 18, which extends along the outer edges of the lid 18. The lid 18 also includes a protruding rib 38 that extends in three directions in the interior of the lid 18 and engages the larger rib 36, to close the three sides. The protruding rib 38 alternatively has four sides, depending on the shape of the channel 32. The lid 18 further includes a protruding rib 40 that extends in four directions and forms an enclosed shape. The protruding rib 40 alternatively has three sides, depending on the shape of the channel 34.

The ribs of the lid 18 are each slightly wider than the channels of the tray 20. The ribs are also made of a suitably deformable material, such that the ribs press-fit into the channels to form a seal. The amount of deformation and the frictional characteristics of the materials are designed such that the consumer can open the lid 18, using a reasonable amount of force. After opening the lid 18, the ribs are flexible enough so that they expand to their original shape to allow the consumer to reseal the lid 18.

In this embodiment, when the consumer closes the lid 18 onto the tray 20 of the container 10, the rib 36 mates with the channel 30 and substantially seals the entire tray surface 22. Further, when the consumer closes the lid 18, the rib 38 mates with the channel 32 and seals the wet food compartment 26, and the rib 40 mates with the channel 34 and seals the wet food compartment 28. It should be appreciated that other seal embodiments would likewise be adaptable to seal the entire tray and/or individual compartments.

In the illustrated embodiment, the container 10 substantially seals the entire tray surface 22 and any pet food contained therein via the rib 36/channel 30 interface. The container 10 also individually seals the wet pet food compartments 26 and 28, via their respective rib/channel interfaces, so that wet food cannot ran onto the tray surface 22 and into the other food compartments, etc. The container 10 also includes individually sealing the dry pet food compartment 24 in the manner herein described, so that chips, crumbs or small pieces of dry pet food cannot slide into open spaces between the tray surface 22 and the inner wall of the lid 18. If desired, the lid can be designed so as to only seal the tray surface 22 and not individually seal the wet pet food compartments 26 and 28. For example, the lid can seal the tray surface 22 when the wet foods are paste-like versus sauce-like and are thick enough not to separate and/or run out of and into the other compartments.

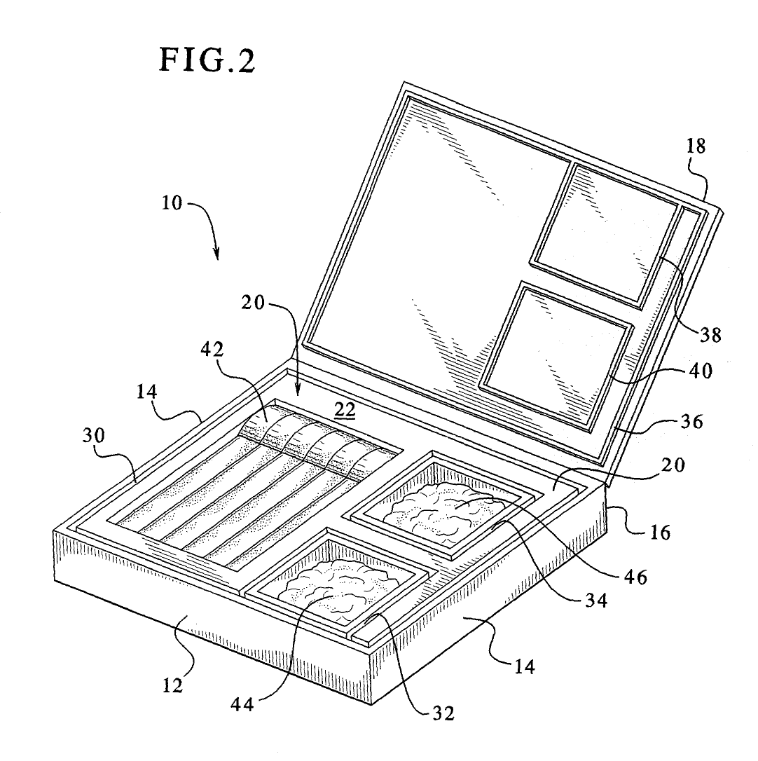

Referring now to FIG. 2, the container 10 is illustrated packaged or loaded with dry and wet pet food. The dry food compartment 24 includes a plurality of dry pet food dipping units 42, which are packaged side by side in an efficient and orderly manner. The wet food compartment 26 includes a quantity of wet pet food 44. The quantity of wet pet food 44 preferably enables the lid 18 to be closed without contacting and placing an excessive amount of force on the wet pet food 44. The wet food compartment 28 includes a similarly appropriate quantity of a different wet pet food 46.

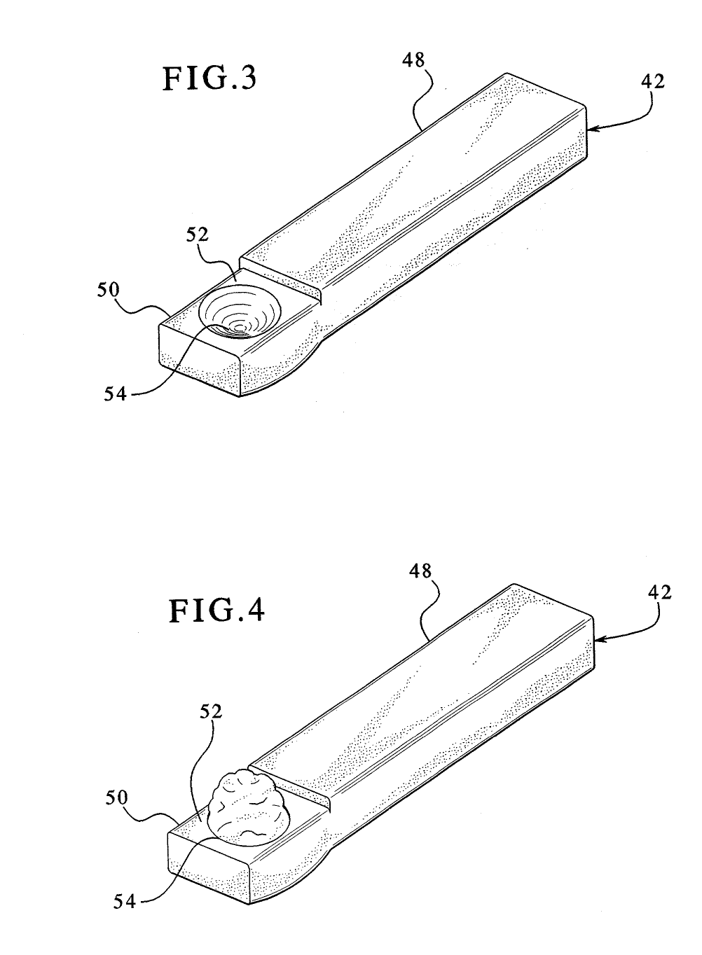

Referring now to FIGS. 3 and 4, perspective views of the dry dipping unit 42 alone and in combination with wet pet food are respectively illustrated. The dry food unit 42 is adaptable to be made from any known dry pet food components and in an embodiment is baked. The dry food in certain embodiments includes functional foods or food ingredients. The functional foods or ingredients include, among other items, vitamins, minerals, insoluble or soluble fibers, functional extracts and probiotic microorganisms, moieties of their cultures, their cell fragments, supernatants of their cultures and other metabolic moieties. In an embodiment, the dry pet food includes a powdered meal supplement.

In the illustrated embodiment, the dry food unit 42 includes a handle portion 48 and a dipping portion 50. A variety of shapes and designs can be used for the dry food unit 42. For example, if a spoon shape is desired, the handle portion 48 can have a circular, elliptical, square, rectangular or other shaped cross-section and a flat or rounded end. In a preferred embodiment, the handle portion 48 as well as the middle between the handle and dipping portions are rectangular and have flat sides. The dipping portion 50 can include a partially circular, elliptical, square, rectangular or other shaped cross-section and a flat or rounded end. In a preferred embodiment, the dipping portion 50 is also preferably rectangular and has flat sides and a flat end. The dipping portion 50, however, also includes one or both of a flat dipping surface 52 and/or an indentation 54, which in one preferred embodiment is spoon shaped and defined by a rectangular dipping portion 50.

The flat surface 52 and the indentation 54 are adapted to hold or support a quantity of wet pet food, whereby the pet owner or consumer: (i) grasps and holds the handle portion 48; (ii) dips the dipping portion 50 in the wet pet food; (iii) extracts a quantity of wet food from its compartment onto the flat surface 52; (iv) maneuvers the pet food combination via the handle portion 48; and (v) feeds either the wet food or the dry food/wet food combination to the pet.

The wet pet foods, such as wet foods 44 and 46, can include any type of commercially available wet pet food but preferably are highly palatable sauces, gravies, gels and/or pastes. The sauces or pastes are formulated with oils, fats and other dry materials, so that the wet pet food is shelf stable and requires no preservatives. The sauces, gravies and pastes are palatability boosters and/or nutritional supplements. The nutritional supplements include, among other items, vitamins, minerals, prebiotics and probiotics, etc. Edible gels can also be provided as a carrier to pharmaceuticals or neutriceuticals or other functional ingredient. The gel is preferably semi-fluid and can be dropped over or spread over the dry food so as to deliver a meal supplement that is directed to providing a health benefit to a pet if desired.

As stated above, the tray 20 of the container 10 includes any number of wet food compartments. The tray 20 likewise includes any combination of pastes and sauces. The dry dipping unit 42 preferably includes an indentation 54 when the container 10 packages sauces or thinner pastes. The flat surface 52 suffices for thicker pastes.

The tray is filled sequentially with the wet and then the dry components, preferably under a protected atmosphere. The atmosphere should be both oxygen and moisture-free. Those skilled in the art are well versed in using a dry, inert gas, such as nitrogen, to blanket an area of the packaging process where the wet and dry components fill into the tray.

The container 10 as herein disclosed provides a self-contained and portable method and apparatus for providing highly palatable and nutritional pet food snacks to pets. The container 10 enables the pet owner to transport the container to a park, etc., provide a portion of the nutritional dry food 42 and one or more wet foods 44 or 46, reseal the unused pet food and transport the container 10 home for future use. Each of the shelf stable pet food snacks is sufficiently sealed within the container 10 so that individual packaging is not necessary. Providing the pet food snacks of the present invention to the pet therefore produces virtually no waste, which further enhances the portability of the container 10.

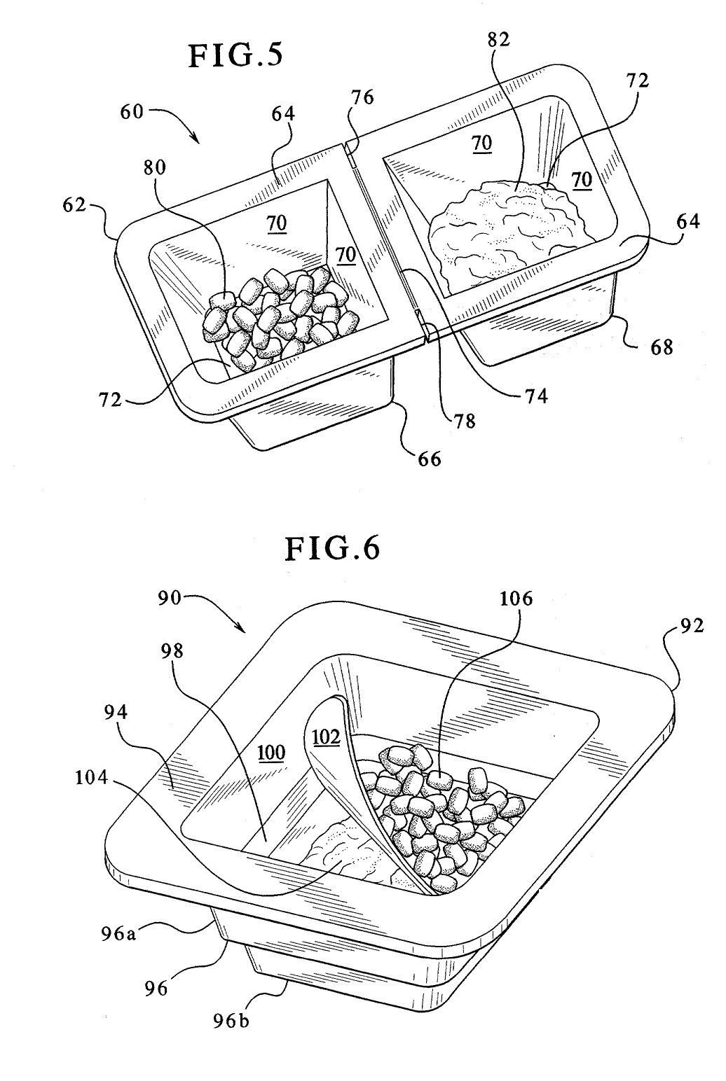

Referring now to FIG. 5, an alternative embodiment of the present invention is illustrated by the container 60. The container 60 is constructed of any of the materials described above in connection with FIG. 1. The container 60 includes a tray 62 that defines a tray surface 64. A plurality of compartments 66 and 68 extend from the tray surface 64. Each of the compartments 66 and 68 include side walls 70 and a bottom wall 72. Container 60 may include any number of compartments greater than one and is not limited to the two illustrated compartments.

At least one pair of compartments, such as compartments 66 and 68, reside on opposite sides of a hinge 74, defined by the surface 64, so that the compartments of the pair mate with one another when the container 60 is folded along the hinge 74. The hinge 74 may simply be a crease in the tray surface 64 although more elaborate hinges may be provided as is well known in the art. The hinge in an embodiment is slit along the sides 76 and 78 a suitable distance to facilitate folding the container 60. The compartments of the pair can, but do not have to be, the same size. A single compartment on one side of the hinge 74 may be adapted to mate with any number of compartments disposed on the opposite side of the hinge 74.

One type of pet food is placed in a compartment on one side of the hinge 74, while another type is placed on the opposite side. When the container 60 is opened and folded along the hinge 74, the different types of pet foods mix to form a desired pet food combination. In the illustrated embodiment, the container 66 includes a dry or semi-moist product 80. The dry food product 80 may be any type of dry pet food described above and have the shape disclosed in connection with FIGS. 3 and 4. The dry food 80, as illustrated, is alternatively provided in smaller sized portions, such as nuggets, pellets, kibbles, etc.

In the illustrated embodiment, the container 68 includes a wet pet food product 82. The wet food product 82 may be any type of wet pet food described above. The wet pet food may alternatively include water or milk. A cover (not illustrated) covers both compartments 66 and 68. The container 60 in an embodiment is packaged in the unfolded position, as illustrated in FIG. 5. The container 60 is alternatively packaged folded along the hinge 74, e.g., to save space, etc., wherein container 60 is unfolded, opened (cover removed) and refolded.

It should be appreciated that container 60 may alternatively include a pair of opposing compartments that house two different types of dry or semi-dry pet food products. Container 60 may further alternatively include a pair of opposing compartments that house two different types of wet pet food products.

Referring now to FIG. 6, an alternative container 90 having vertically stacked food components is illustrated. The container 90 is constructed of any of the materials described above in connection with FIG. 1. The container 90 includes a tray 92 that defines a tray surface 94. One or more compartments, such as the compartment 96, extends from the tray surface 94. Each of the compartments includes a rim 98 which extends around the side walls 100 of the compartment. Container 90 may include any number of the rimmed or tiered compartments and is not limited to the one illustrated compartment 96.

A divider 102 illustrated partially peeled back seals directly to the rim 98 so as to divide the compartment 96 into an upper sub-compartment 96a and a lower sub-compartment 96b. The seal can include a heat or induction seal or employ an adhesive suitable for consumable pet food packaging. It should be appreciated that container 90 may be modified to include a plurality of rims, such as rim 98, to create more than two sub-compartments.

The sub-compartments 96a and 96b house different types of food products as described above. In an embodiment, the lower sub-compartment 96b houses a wet food product 104 that includes any of the wet pet food products described above, while the upper sub-compartment 96a houses a dry food product 106 that includes any of the shapes and types of dry pet food products described above. In this embodiment, the dry food 106 is removed from the upper sub-compartment 96b, the divider 102 is opened and/or removed and either: (i) the wet food 104 is poured into a separate container that currently holds the dry food 106; or (ii) the dry food 106 is poured back into the container 90 and mixed with the wet food 104.

In an alternative embodiment, the lower sub-compartment 96b houses the dry food 106, while the upper sub-compartment 96a houses a wet food product 104. In one implementation, the wet food 104 is of such a viscosity that the divider 102 may be perforated or torn so that the wet food runs through the divider 102 to the lower sub-compartment 96b. The lower sub-compartment 96b contains enough space so that all the wet food 106 drains through, whereby the divider may be removed.

A cover (not illustrated) covers the compartment 96 on the surface 94 of the tray 92. The divider 100 and the cover are each, in an embodiment, a thin plastic or moisture impermeable sheet or other sheet material that is coated with a plastic or moisture impermeable layer. In an alternative embodiment, the surface 94 of the tray 92 defines a pair of compartments on either side of a crease (FIG. 5), so that one multi-food compartment may fold over another multi-food compartment.

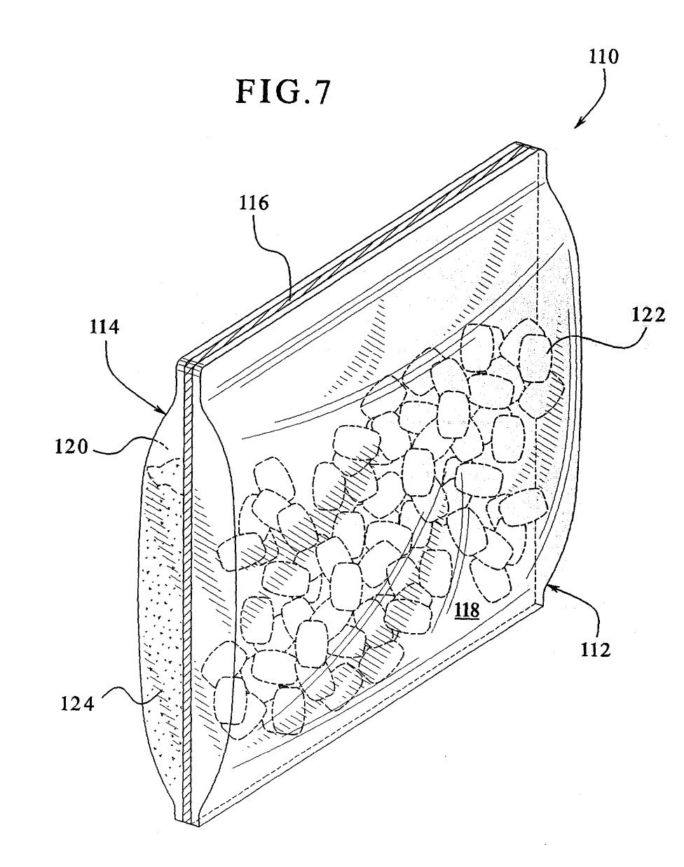

Referring now to FIG. 7, an alternative flexible pouch container 110 is illustrated. The flexible pouch container 110 is made of any suitable flexible, moisture impermeable material such as a plastic sheet, thin metal foil or other material coated with plastic or a thin metal foil. The container 110 defines a plurality of separate compartments 112 and 114, which are separated by a flexible, moisture impermeable divider 116 made of a suitable material as disclosed above. The divider 116 is therefore a wall common to both the compartments 112 and 114. The divider 116 is illustrated as being disposed substantially parallel to the faces 118 and 120 of the compartments 112 and 114, respectively. The divider 116 may alternatively be disposed substantially perpendicular to the faces 118 and 120 of the compartments 112 and 114.

The compartments 112 and 114 house different types of pet food products as disclosed above. In the illustrated embodiment, compartment 112 holds a dry or semi-dry food product 122, while compartment 114 holds a wet food product 124. As before, the compartments 112 and 114 may alternatively both house different dry or semi-dry food products or different wet food products.

In an embodiment, the divider 116 is at least partly removable to allow communication between the products 122 and 124 of the compartments 112 and 114 and at least some pre-mixing of the products prior to dispensing. In one implementation, the divider 116 is removable by exertion of pressure on one or both of the faces 118 and 120 which is sufficient to rupture the divider 116. The divider seal is therefore of less strength than that of the external faces 118 and 120 of the compartments 112 and 114 of the container 110.

In another embodiment the faces 118 and 120 peel away from the divider 116 so that the products 122 and 124 can pour simultaneously into a separate container. In a further alternative embodiment, the container 110 includes two completely separate pouch compartments (not illustrated), i.e., not separated by a divider 116 but attached along a common edge instead. Here, the separate compartments each include a seal that is broken to pour out the products.

Any of the embodiments for the flexible pouch container 110 may be split into any number of separate compartments using multiple dividers 116 or by providing multiple completely separate compartments. Further, one or more of a pair of completely separate compartments attached along a common edge may include a divider 116, so that three or more food products can be mixed and dispensed.

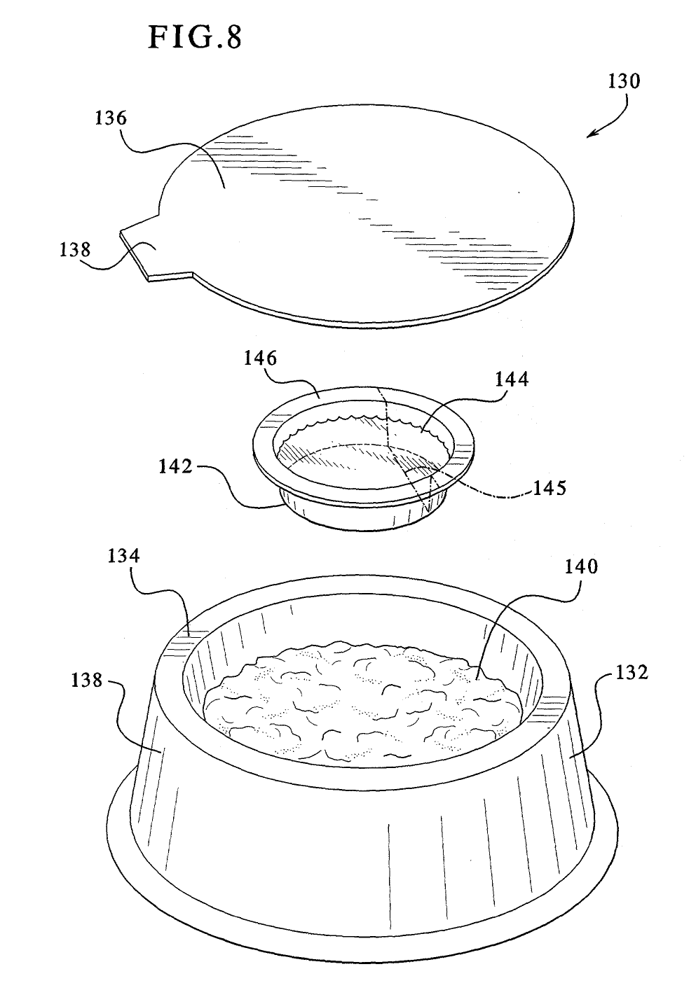

Referring now to FIG. 8, a further alternative multi-component pet food container 130 is illustrated. The container 130 includes a housing or bowl 132 (hereafter “bowl”). The bowl 132 is in an embodiment molded plastic. In other embodiments, the bowl 132 may be made of other suitable materials such as a moisture-impermeable cardboard or paper product or, a light weight metal or a metal foil. The bowl 132 is further alternatively made from any combination of these materials. The bowl 132 is shaped and produced so that a consumer can directly serve the pet food in the bowl 132 to a pet. Therefore, the bowl 132 includes an edge or rim 134 that will not cut or otherwise harm a pet when the pet eats from the bowl 132. The rim 134, for example, may be rounded or flat.

Because the consumer serves the bowl 132 and the pet food contained therein directly to the pet, the bowl 132 or at least the rim 134 should be made of a tasteless or odorless material. For example, certain metals may yield an undesirable taste. These metals and other materials that may taint the taste of the pet food are therefore avoided in a preferred embodiment.

The bowl 132 is also microwaveable in an embodiment. The bowl as described below includes a number of pet foods. The taste and palatability of certain pet foods may be enhanced through heating. A plastic bowl 136 having a plastic lid 136 can be placed in a microwave oven and heated.

The lid 136 seals to the bowl 132. The lid 136 may seal to the rim 134 or seal to the side wall 138 of the bowl 132. The lid 136 seals to the bowl 132 by any method known to those of skill in the art. The seal can include a heat or induction seal or employ an adhesive suitable for consumable pet food packaging. In an embodiment (not illustrated) the lid 136 is resealable to the bowl 132. The resealable lid 136 may employ any of the techniques described above to reseal to the bowl 132. Alternatively, if an adhesive is employed, the lid in an embodiment is resealed to the bowl 132 using the adhesive.

The lid 136 is also adaptable to be made from a paper product, plastic, or from a metal or metal foil. The lid 136 can be made using a plurality of materials, for example, by applying a thin layer of wax or metal foil to a paper or paper product layer. The lid 136 defines a tab, member or removal mechanism 138. In the illustrated embodiment, the tab or member 138 extends from the edge of the lid 136. In another embodiment, the tab or member 138 is disposed within the interior of the lid 136, wherein the tab 138 lies flat on the top surface of the lid 136. When a consumer desires to remove the lid 136, the consumer lifts the tab or member 138 from the top surface of the lid 136 and pries the lid from the bowl.

The container 130 houses a plurality of different types of pet foods. The bowl 132 can contain a quantity of dry or semi-dry pet food 140. The dry or semi-dry pet food 140 can be any of the dry or semi-dry pet foods that have been disclosed above. Preferably, a separate package or pouch 142 houses a wet pet food 144. The wet pet food 144 can likewise be any of the wet pet foods disclosed above. In an embodiment, the wet pet food 144 is a non-viscous gravy, broth, or other liquidous taste-enhancing pet food or pet food component.

In an embodiment, the package or pouch 142 holds a medicated pet food. The wet pet food 144 in an embodiment includes a dosage amount of a pharmaceutical, medicament or neutraceutical, preferably in an amount suitable for the size of the meal or alternatively in an amount suitable as a dosage for a pet. The pharmaceutical, neutraceutical or medicament may be encapsulated in a suitable protective encapsulation matrix (e.g., having suitable carbohydrates such as gum arabica) to provide a barrier against degradation and to avoid possible palatability rejection (depending on the ingredient supplied). For example, the pharmaceutical, neutraceutical or medicament can be provided in the form of tiny sugar coated pills in a gravy carrier so they easily pour onto the dry food. Also, the pills would not dissolve until being digested by the pet.

The package 142, in an embodiment, completely surrounds the wet pet food 144. That is, although not illustrated in FIG. 8, the package 142 contains a separate lid that covers the wet pet food 144, e.g., the gravy or broth. The separate lid is then adhered to or otherwise attached to the underside of the lid 136. In another embodiment, the package 142 as illustrated does not contain a separate lid. Here, a rim 146 extending around the edge of the package 142, suitably adheres to the underside of the lid 136.

When the consumer removes the lid 136 from the bowl 132 via the tab 138, the package 142 simultaneously and automatically tears open so that the e.g., non-viscous wet pet food 144 spills out over the dry or semi-dry pet food 140. In an embodiment the package 142 is made of a thin plastic or paper material that tears due to the force applied to the lid 136 by the consumer. For example, the lid 136 may be adapted to buckle upon its removal, wherein the package tends to tear at a point or seam of the package 142 at or along the buckle line of the lid 136.

The package 142 of the container 130 in an embodiment is frangible, breakable and/or tearable. When the consumer peels away and folds back the lid 136, the removal or peeling back of the lid causes the package 142 to break. That is, the package 142 is too brittle to withstand the stresses caused by the removal or folding over of the lid 136. A line of weakness 145 or tear line of the package 142 occurs in an embodiment towards one end or base of the package.

The lid 136 is structured in an embodiment to peel approximately half way from the bowl 132. Afterward, the peeled away portion of the lid 136 buckles or bends vertically upward with respect to the portion of the lid 136 that remains momentarily attached to the rim 134 of bowl 132. The action of the portion of the lid 136 bending upward to a vertical or substantially vertical position causes the package 142 to stretch and tear, preferably along the tear line or line of weakness 145. In the vertical or pseudo-vertical position, the package 142 fractures and the broth or wet pet food 144 pours out into a center portion of the dry pet food 140 in an embodiment.

In another embodiment, the lid 136 contains a device that tears or cuts the package 142, which may or may not be along a predisposed line of weakness, such as tear line 145, when the consumer pulls the tab 138 and deforms the lid 136. Thus, in one step, the consumer opens the container 130 of the present invention and prepares the combination dry pet food/wet pet food meal. The consumer may immediately thereafter serve the combination meal in the bowl 132 to the pet. No external opening device or utensil is needed.

It is also contemplated that the bowl 132 of the present invention only contains the dry or semi-dry pet food 140. Here, the consumer removes the lid and is thereafter able to serve the bowl 132 and its dry pet food 140 to the pet.

In one embodiment, the container 130 contains a quantity of the dry pet food 140 and the wet pet food 144, wherein the quantity is consumable by the pet in one sitting or in one period. Alternatively, a greater quantity of the pet foods may be provided, wherein the lid 136 is resealable as described above. In a preferred embodiment, the container 130 is disposable so that the consumer does not have to perform any cleanup after serving the multi-component pet food to the pet.

The bowl 132 in an embodiment is sized to be inserted, stored, and dispensed from well known vending machines. The seal created by the lid 136 seals the dry pet food and keeps the dry pet food fresh while the container 130 resides within the vending machine. Also, the package 142 keeps the wet pet food 144 fresh during this same period.

In another embodiment, the container 130 is sized to be dispensed at a quick-service restaurant. The container 130 is inserted into a bag containing other quick-service restaurant items. The quick-service restaurant operator then dispenses the bag either through a pull-up window or at a counter within the quick-service restaurant. Of course, the container 130 may be distributed from a supermarket or a convenience store as is well known in the art.

The container 130 of the present invention is therefore readily obtained at remote locations and readily transported from home to the remote locations. At the remote locations, such as a campsite or park, the container 130 provides a readily accessible and palatable multi-component pet food product to serve at any time to the pet. The consumer does not require an opener to remove the lid 136 from the bowl 132. The consumer does not need to soil or otherwise dirty any utensils in serving the pet food product and can easily dispose of the lid 136 and body 132 after the pet food is consumed.

While the alternative container 130 is shown as having two pet food components: namely, the dry food component 140 and the wet food component 144, the alternative container 130 may include one or more of each of these. For instance, one or more divider walls (not illustrated) may be disposed within the bowl 132 to hold a plurality of dry pet food components 140. Also, a plurality of packages 142 holding different types of wet pet foods 144 can be attached to the underside of the lid 136. Or, a single package 142 can have multiple compartments as disclosed above in connection with FIG. 7. Here, a separate wet pet food 144 may be positioned above a particular dry pet food 140 to disperse upon said dry pet food 140. A second dry pet food 140 may then either not be contacted by a second wet pet food or may be contacted by a different wet pet food 144.

As illustrated, the package 142 is disposed directly under the lid 136 and above or otherwise surrounded by the dry pet food 140. The present invention can alternatively configure the pet food components so that the wet pet food package 142 is disposed underneath or within the dry pet food 140 or alongside the dry pet food 140. Preferably, however, regardless of the configuration of the different types of pet foods, the wet pet food or gravy 144 automatically disperses and dispenses onto or into the dry pet food 140 when the consumer removes the lid 136. For example, if the wet pet food 144 is disposed within the dry pet food 140, the lid 136 can include a suitable member that pokes through the dry pet food 140 and punctures the gravy package 142 when the consumer removes the lid 136.

It should be understood that various changes and modifications to the presently preferred embodiments described herein will be apparent to those skilled in the art. Such changes and modifications may be made without departing from the spirit and scope of the present invention and without diminishing its attendant advantages.

We claim:

1. A container including pet food comprising:
a housing;
a first pet food disposed within the housing;
a second pet food disposed within the housing separately from the first pet food;
a lid removably attached to the housing and so constructed and arranged that the removal of the lid causes at least portions of the first and second pet foods to contact each other when the lid is removed from the housing.

2. The pet food container of claim 1, wherein the housing is plastic.

3. The pet food container of claim 1, wherein the housing is sized to be dispensed from a vending machine.

4. The pet food container of claim 1, wherein the lid is resealable.

5. The pet food container of claim 1, wherein the first pet food is dry and the second pet food is wet.

6. The pet food container of claim 1, wherein the first pet food is semi-dry and the second pet food is wet.

7. The pet food container of claim 1, wherein the second pet food is stored in a package, the package disposed inside the housing and ruptured when the lid is removed from the housing.

8. The pet food container of claim 7, wherein the package is predisposed to tear along a tear line of the package.

9. The pet food container of claim 7, wherein the lid is predisposed to buckle and thereby cause the package to rupture.

10. The pet food container of claim 1, wherein the second pet food is stored in a package and the lid punctures the package when the lid is removed from the housing.

11. The pet food container of claim 1, wherein the second pet food is disposed directly underneath the lid and above the first pet food.

12. The pet food container of claim 1, wherein the second pet food is medicated.

13. A container for serving pet food to a pet comprising:
a bowl;
at least two different types of pet food maintained within the bowl;
a lid that seals to the bowl and maintains pet food freshness; and
a member extending from the lid for grasping and removing the lid from the bowl to allow the pet to access same.

14. The pet food container of claim 13, wherein the lid seals to the rim and the member extends from the rim along an edge of the lid.

15. The pet food container of claim 13, wherein the member is disposed on top of the lid.

16. The pet food container of claim 13, wherein the bowl is sized to hold a quantity of the pet food, the quantity consumable in a single feeding.

17. The pet food container of claim 13, wherein the bowl is adapted to be placed in a microwave oven.

18. A method for manufacturing a pet food container comprising:
producing a container housing separated first and second pet foods, the container having a removable lid that automatically places at least a portion of the first and second pet foods into contact when the lid is removed, the container having a bowl housing the first and second pet foods, the bowl suitable for serving the contacted first and second pet foods.

19. The method of claim 18, wherein the second pet food is wet pet food that is stored in a package that automatically ruptures when the lid is removed from the container.

20. The method of claim 18, which includes distributing the container to a retail outlet selected from the group consisting of: a supermarket, a convenience store, a quick service restaurant and a vending machine.

21. A method for providing a pet food comprising:
providing a container housing separated first and second pet foods, the container having a removable lid that causes at least portions of the first and second pet foods to contact each other when the lid is removed, the container having a bowl housing the first and second pet foods, the bowl suitable for serving the pet foods; and
opening the container and serving the pet foods to a pet.

22. The method of claim 21, wherein opening the container includes unsealing the lid from the bowl.

23. The method of claim 21, which includes serving the pet foods without any additional tool/utensil.

24. The method of claim 21, which includes serving a mixture of wet and dry pet foods.
